(19) United States
(12) Patent Application Publication
(10) Pub. No.: US 2006/0026537 A1
(43) Pub. Date: Feb. 2, 2006

(54) A Voice Controlled Cursor

(75) Inventor: Antoine L'Heureux, Winchester, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/161,029

(22) Filed: Jul. 20, 2005

(30) Foreign Application Priority Data
Jul. 28, 2004 (GB) 0416773.0

(51) Int. Cl. G06F 3/00

(52) U.S. Cl. 715/863; 345/157; 715/856; 715/865

(57) ABSTRACT

The invention is directed to a voice controlled cursor, location pointer, mouse pointer or the like whereby a user's spoken input or inputs indicative of both a direction and a distance are employed to directly move the cursor from its current position towards a target position on a display of a graphical user interface (GUI) of a computing device. The cursor has a navigational marker associated therewith. In a first step, the marker is moved in response to at least one set of direction and distance indications inputted by a user to the computing device prior to moving the cursor to be co-incident with the marker at its new position. The marker is provided to enable a user to position it at a target position for the cursor prior to moving the cursor to said position.

The present invention concerns a voice controlled cursor, location pointer, mouse pointer or the like whereby a user's spoken input or inputs indicative of both a direction and a distance are employed to directly move the cursor from its current position towards a target position on a display of a graphical user interface (GUI) of a computing device.

### BACKGROUND TO THE INVENTION

International Business Machines Corporation (IBM) provides a voice recognition software product under the name “ViaVoice” (ViaVoice is a trademark of IBM). This software can be used on many different types of computing devices such as personal computers (PCs) and handheld computer platforms or the like and frees users from dependence on a mouse, a keyboard and/or a stylus for many applications. Control of applications and functions such as the position of a cursor can be achieved through user voice commands.

In a computing device executing the ViaVoice voice recognition application, the position of the GUI cursor on a display can be controlled through voice commands comprising directions such as “up”, “down”, “left” and “right” in combination with spoken instructions such as “faster”, “slower”, “stop”, etc. While this achieves the aim of freeing a user from using a mouse, stylus or the like to control the position of the cursor, it is a slow and generally inaccurate means of controlling the position of the cursor on the GUI display. Also, it normally requires a multiplicity of voice command inputs to reposition the cursor at a target position, thus utilising valuable processing power merely for this purpose. It also requires the constant attention of the user while performing a cursor repositioning process.

U.S. Pat. No. 5,818,423, assigned to Dragon Systems, Inc., discloses another approach to using voice commands to control the position of a cursor on a computer display. Instead of moving a cursor along a continuous path towards a target position, the cursor is jumped discontinuously through a sequence of discrete positions that home in from its original location to a target location in response to user voice commands.

The user specifies through said voice commands the discrete positions along the sequence with the aid of a displayed mouse grid. The mouse grid subdivides the display screen or a portion of the screen into equal sized labelled sub-regions. The user indicates the next position for the cursor in the sequence of positions by voicing a command that identifies the label of the sub-region that contains the target location. The grid is then immediately scaled down to a next level to cover the selected sub-region with the cursor being relocated to the centre of this region. The scaled down grid subdivides the selected sub-region into a set of smaller sub-regions and the process is repeated until the cursor is eventually positioned at the target location.

This approach to controlling the position of a cursor through voice commands also normally requires a multiplicity of voice command inputs to reposition the cursor at a target position. Also, if, at any of the levels, a user specifies an incorrect sub-region, then the process must be commanded to return to the previous level containing the correct sub-region to allow the user to select said sub-region thereby effectively repeating that level and thus prolonging the cursor repositioning process. In other words, the process must effectively repeat a step to allow an erroneous sub-region selection to be corrected rather than enabling a correction to be made that more directly addresses the consequences of such an erroneous selection.

U.S. Pat. No. 6,668,244, assigned to Quartet Technology, Inc., discloses yet another approach to using voice commands to control the position of a mouse pointer on a computer display. This discloses a mouse pointer (cursor) displayed on the computer screen including a circular arrangement of equally spaced direction pointers identified by numeric characters (numbers) surrounding the cursor. To control the position of the cursor, a user inputs as a voice command a selected number. The cursor is controlled to move towards the selected number until the user inputs a stop command.

While this approach to controlling the position of a cursor normally requires fewer voice commands than that of the IBM ViaVoice system or that disclosed in U.S. Pat. No. 5,818,423, it requires the constant attention of the user who is required to issue a stop voice command immediately the cursor reaches a target position. Consequently, the process of repositioning the cursor is dependent to some degree on a user's reactions and attentiveness. Also, the circular arrangement of numeric direction pointers surrounding the cursor clutters the screen.

### OBJECT OF THE INVENTION

It is an object of the invention to mitigate and/or obviate problems associated with the aforementioned prior art methods of controlling the position of a cursor through voice commands.

It is another object of the invention to provide a method of controlling the position of a cursor on a computer display screen that is not dependent on a user's reactions and/or attentiveness.

It is a further object of the invention to provide a navigation aid to assist with the repositioning of a cursor on a computer display screen or the like.

### SUMMARY OF THE INVENTION

In a first aspect, the present invention provides a method of moving an element displayed on a computer display from a current position thereof towards a target position, the method being characterised in that it comprises the steps of: receiving a user's input indicative of a direction and a distance; and moving said element from its currently displayed position directly to a new position defined by a direction and by a distance derived from the user's input.

An advantage offered by the present invention is that the system is configured to act on precise commands input by a user and consequently does not require the user's constant attention during the cursor repositioning process.

Preferably the display element has a navigation marker associated therewith.

In one arrangement, the navigation marker may be moved from its currently displayed position coincident with the display element in a direction and a distance derived from the user's input with the display element being moved simultaneously with the navigation marker.

Preferably, however, the navigation marker is moved from its currently displayed position in a direction and a distance derived from the user's input prior to moving the display element to a new position of the navigation marker.

This enables a user to see what the effect of an input command would be on the position of the curser that is advantageous where the curser is moved to a new position of the marker as a subsequent step.

Preferably also, the step of moving the navigation marker from its currently displayed position in a direction and a distance derived from the user's input is repeated a number of times until the navigation marker is at or adjacent the target position and only then performing the step of moving the display element to the new position of the navigation marker.

This enables the user to use a number of input commands to fine tune the position of the curser at the target position prior to the curser being moved to said position.

In a preferred embodiment, the user's input is received as a voice input and the method includes the step of processing said user's voice input using a voice recognition application and/or module to recover data indicative of the direction and the distance selected by the user.

Thus, a user is able to reposition the curser through the use of a voice input or voice inputs containing information indicative of two commands, namely a direction indication and a distance indication each of that can be acted on without requiring further input by the user during the implementation of these commands.

The display element comprises a windowed graphical user interface (GUI) cursor, location pointer, mouse pointer or the like.

The method may include the step of prompting a user to provide a direction indication and a distance indication as a single input.

Alternatively, the method may include the step of prompting a user to provide one of a direction indication and a distance indication as a first input in a series of inputs and the other of the direction indication and the distance indication as a subsequent input in said series of inputs.

That part of a user's input or inputs indicative of a direction may comprise any of an angle relative to a datum, a compass direction relative to the orientation of the computer display or an alpha-numeric character or code encoding an angle or a direction indication.

For example, the datum may comprise a hidden and thus imaginary to the user horizontal line across the display. The user inputs as a direction indication an angle selected from the range of 0 to 360° or +/−180°. This hidden line may be visualised by the user as being parallel to a bottom edge of the display screen, for example.

In another arrangement, the display screen can be considered as equivalent to a compass wherein the top of the screen represents north, the bottom south, left side west etc and a user inputs as a direction indication a compass direction of “north-east”, for example.

In a preferred arrangement, specified directions relative to the cursor and or navigation marker are represented by alpha-numeric characters or codes thus providing a user with a form of input for specifying a direction indication that will be understood by the computing device processor. The distance indications may be similarly represented or encoded.

Preferably, the navigation marker associated with the display element includes at least one line displayed on the computer display, said line extending generally radially outwardly from said navigation marker.

Preferably also, the navigational marker includes a plurality of radially extending lines centred on said marker.

The plurality of radially extending lines enables a user to more easily visualise an appropriate direction indication and to select the appropriate alpha-numeric character or code for the selected direction.

The number of the plurality of radially extending lines may be determined from a user's previously entered preferences or settings. The user may establish settings for other features relating to implementation of the navigation marker including the position the marker is presented at on screen when the marker is “switched on”.

Preferably, the method includes the step of subdividing a space bounded by a line selected by a user as its inputted direction indication and a next of said plurality of the lines of the navigation marker and displaying further radially extending lines within said space in response to a further user input.

This is beneficial where the number of lines comprising the plurality of lines is small and thus the spaces between them are large, relatively speaking. The user is then able to introduce more closely spaced direction lines in a space or sector of interest rather than cluttering the whole screen with a large number of direction lines extending in all directions outwardly from the marker.

Preferably, the further lines are identified or represented ion screen in the same manner as existing direction lines.

Alternatively or additionally, the navigational marker can be rotated in response to a user input.

Consequently, the user can identify any direction from the entire range of directions surrounding the marker. This is particularly advantageous where the marker includes only one or a small number of direction lines.

Preferably, at least one radially extending line of the navigation marker is subdivided into a plurality of distance indications.

Preferably also, each of said subdivided distance indications of the at least one radially extending line has an alpha-numeric character or code associated therewith, wherein input of a selected code by a user comprises the user's distance indication.

The size of the subdivided distance indications may vary over the length of the radially extending line and the subdivided distance indications may be smallest closest to the marker. The size may vary exponentially with distance from the marker.

Preferably, the subdivision of the at least one radially extending line into a plurality of distance indications is not displayed until a user has input a direction indication.

By displaying a distance subdivision of only the direction line selected by a user prevents the screen from becoming cluttered with navigation marker information elements.

The marker may be displayed in response to a user input. Thus, the marker is only displayed if requested by a user.

In a second aspect, the invention provides a data processing system comprising: a processor; a memory coupled to the processor, said memory storing programs executable by the processor; a display screen coupled to the processor for displaying images under the control of programs being executed by the processor; the programs stored on the memory including a program for creating a graphical user interface (GUI) on the display screen; wherein said GUI is responsive to a user's input indicative of a direction and a distance to move a display element from its currently displayed position on the screen directly to a new position defined by a direction and by a distance derived from the user's input.

In a third aspect, the invention provides a machine readable medium comprising computer code executable by a processor of a data processing system having a memory coupled to the processor, said memory storing programs executable by the processor, and a display screen coupled to the processor for displaying images under the control of the programs being executed by the processor, the programs stored on the memory including a program for creating a graphical user interface (GUI) on the display screen; wherein said GUI code is executable to move a display element from its currently displayed position directly to a new position defined by a direction and by a distance derived from a user's input indicative of a direction and a distance.

In a fourth aspect, the invention provides program code embodied on a machine readable medium, said code being executable by a processor of a data processing system having a memory coupled to the processor, said memory storing programs executable by the processor, and a display screen coupled to the processor for displaying images under the control of the programs being executed by the processor, the programs stored on the memory including a program for creating a graphical user interface (GUI) on the display screen; wherein said GUI code is executable to move a display element from its currently displayed position directly to a new position defined by a direction and by a distance derived from a user's input indicative of a direction and a distance.

### BRIEF DESCRIPTION OF THE DRAWINGS

A description of the present invention will follow with reference to the accompanying drawings, of which:

FIG. 1 is a pictorial representation depicting a data processing system in which the present invention may be implemented in accordance with a preferred embodiment of the invention;

FIG. 2 is a schematic block diagram depicting a data processing system in which the present invention may be implemented in accordance with a preferred embodiment of the invention;

FIGS. 3 to 6 are views of a data processing system display screen illustrating various embodiments and methods in accordance with the present invention.

### DETAILED DESCRIPTION OF A PREFERRED EMBODIMENT

The foregoing and further features of the present invention will be more readily understood from a description of a preferred embodiment, by way of example thereof, with reference to the accompanying drawings.

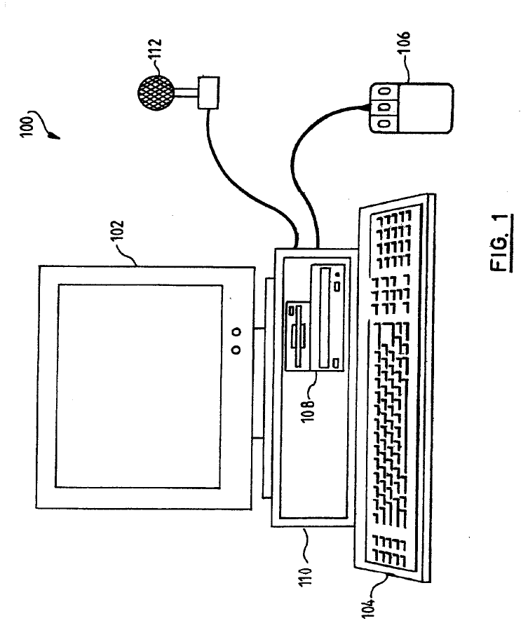

With reference now to the figures and, in particular, with reference to FIG. 1, illustrated is a pictorial representation depicting a data processing system (computing device) in which the present invention may be implemented in accordance with preferred embodiments thereof. A personal computer (PC) 100 is depicted that includes a system unit 110, a video display terminal 102, a keyboard 104, storage devices 108, which may include floppy drives and other types of permanent and removable storage media, a mouse 106 and a microphone 112. Additional input devices may be included with PC 100. PC 100 can be implemented using any suitable computer, such as an IBM compatible PC, Apple Macintosh computer or UNIX based workstation. Although the depicted representation shows a PC, the present invention may be implemented in other types of data processing systems, such as network computers, Web-based television set top boxes, Internet appliances, handheld devices, mobile communication devices etc. PC 100 also includes a graphical user interface (GUI) that may be implemented by means of system software residing in computer readable media in operation within the PC 100.

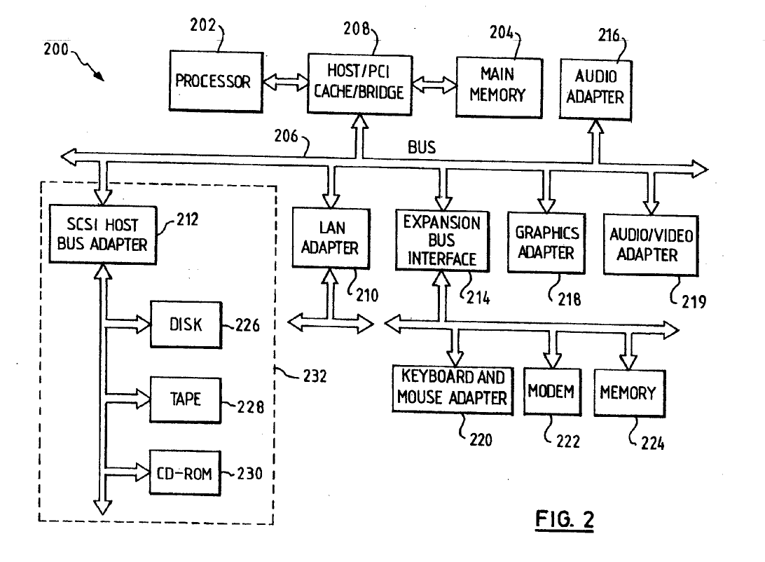

With reference now to FIG. 2, illustrated is a block diagram of a data processing system in which the present invention may be implemented. Data processing system 200 is an example of a computer, such as PC 100 of FIG. 1. Data processing system 200 employs a peripheral component interconnect (PCI) local bus architecture. Although the depicted example employs a PCI bus, other bus architectures such as Micro Channel and ISA may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 of FIG. 2. The operating system may be a commercially available operating system such as Microsoft Windows NT or Windows XP Operating System (OS), the IBM OS/2 operating system, the MAC OS, or UNIX operating system. Applications or programs are located on storage devices, such as hard disk drive 226, and may be loaded into main memory 204 for execution by processor 202. Such applications include a voice recognition application program or module that allows a user to control the interface elements through spoken (voice) commands picked up by the microphone 112 and processed by the processor 202 executing the voice recognition application program. Inputted voice commands are recognised by the processor 202 and are then provided to other software applications and the operating system also being executed by the processor 202 that implement the recognised voice commands. The processes and means for recognising voice commands and their implementation will be familiar to a skilled artisan and need not be discussed in more detail here.

Those of ordinary skill in the art will appreciate that the hardware depicted in FIG. 2 may vary depending on the implementation. Other internal hardware or peripheral devices, such as flash ROM (or equivalent non-volatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by broken line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a Personal Digital Assistant (PDA) device that is configured with ROM and/or flash ROM to provide non-volatile memory for storing operating system files and/or user-generated data.

The depicted example in FIG. 2 and above-described examples are not meant to imply any architectural limitations to the computing device for implementing the preferred embodiments of the present invention. As indicated in the foregoing, the computing device may comprise any suitable computing device having a GUI display employing a cursor, mouse pointer, location pointer or the like.

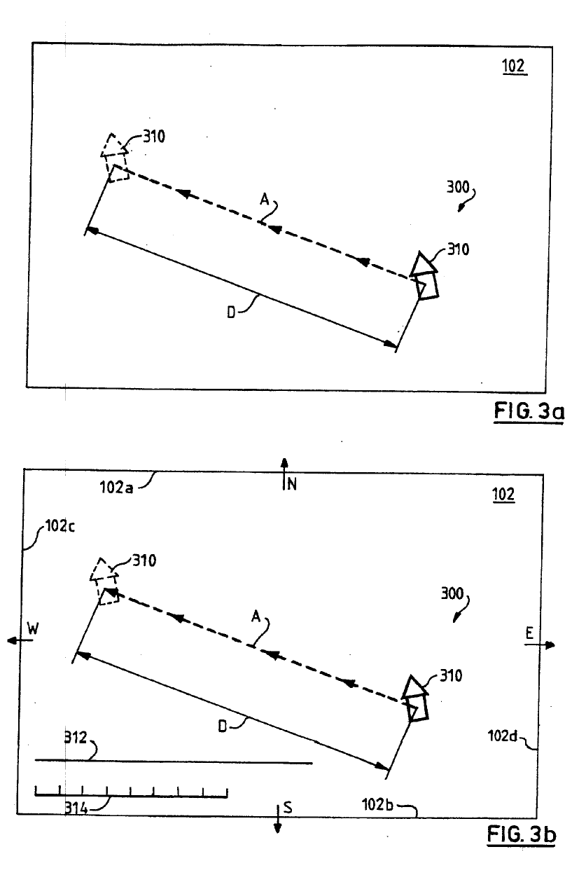

Referring now to FIG. 3a, implementation of a method in accordance with a first embodiment of the invention is illustrated. Shown on a display screen 102 of PC 100 is a display element 300 occupying a current position as depicted by the full-lined arrow icon 310. The display element 300 may comprise a cursor, mouse pointer, location pointer or the like but will be referred to as a cursor in the following description. The position of the cursor 310 can be controlled by use of the mouse 106 and/or keyboard 104. Alternatively, the user can use spoken commands to effect repositioning of the cursor 310.

In the example illustrated in FIG. 3a, a user wishes to reposition the cursor 310 at a new position on the display screen 102 above and to the left of the cursor's current position as indicated by the dotted line form of the arrow icon 310. To effect this repositioning of the cursor 310, the user inputs to the PC 100 a direction indication (illustrated by arrowed line A in the figure) and a distance indication (indicated by distance line D in the figure). On receiving the user's inputted direction and distance indications, the processor 202 controls the GUI to move the cursor 310 in the direction “A” derived from the user's direction indication and by a distance “D” derived from the user's distance indication. Consequently, it is only necessary for the user to provide two pieces of information, namely a direction indication and a distance indication, to cause the cursor 310 to be moved to a new position on the display screen 102.

Advantageously, the method of cursor position control in accordance with the first embodiment of the invention does not require a continuous series of further inputs from the user during implementation of the inputted direction and distance indications.

It will be appreciated that, in the event that the cursor 310 when relocated to its new position does not occupy a target position envisaged by the user, the user can input a further direction indication and a further distance indication to effect a further repositioning of the cursor 310. This can be repeated until the cursor 310 occupies the user's target position.

The method of repositioning the cursor 310 in accordance with the first embodiment of the invention is intuitive since it relies on the user envisaging both a direction and a display screen distance relative to the cursor's current position on the display screen 102. However, with practice, a user will be able to reposition the cursor 310 at a desired target location within one or two iterations.

Referring to FIG. 3b, to assist a user in intuitively determining a direction indication, the PC 100 may be configured to treat the plane of the display screen 102 as representative of a compass face whereby a top edge 102a of the display screen 102 represents the compass direction “north”, a bottom edge 102b represents “south”, a left side edge 102c represents “west” and a right side edge 102d represents “east”. Thus a user can envisage a direction indication as comprising a compass direction such as “north-east” or “west-south-west” for example. The direction indication can be input as a compass direction or as a code indicative of said compass direction selected from a drop menu or window (not shown), for example.

Alternatively, the PC 100 may be configured to provide a datum line 312 on the display screen 102 so that a user can input a direction indication comprising an inclination expressed as an angle with respect to the datum line 312. The datum line 312 may be displayed as illustrated, but in another implementation it is hidden from view but is arranged to be parallel to an edge, e.g. the bottom edge 102b, of the screen 102. In a further arrangement, the PC 100 is configured to enable a user to select to display or hide the datum line 312.

Also referring to FIG. 3b, to assist a user in intuitively determining a distance indication, the PC 100 may be configured to display a scale 314 on the display screen 102 illustrating the size of a distance unit relative to the screen size. This feature is particularly advantageous where the method is implemented in devices having different sized screens where an absolute distance measure may be meaningless. The PC 100 may be configured to enable a user to select to display or hide the scale 314. The datum line 312 may comprise a base line for the scale 314.

User direction and distance indications may be input using any suitable device or means including the mouse 106, the keyboard 104 or even a stylus (not shown). However, the method of the invention is particularly designed to be implemented through spoken commands inputted by a user through the microphone 112 thereby freeing the user from dependence on other manually operated input devices or means. Thus, since the method in accordance with the first embodiment of the invention requires only two elements of information from a user to effect repositioning of the cursor 310, it does not require the user's constant attention during the process of repositioning the cursor 310 in accordance with said information elements, i.e. the user is not required to issue a “stop” command to halt movement of the cursor during a repositioning process as is the case with some of the prior art implementations.

In the following description of other embodiments of the invention all references to user inputs will be made on the assumption that such inputs comprise spoken inputs (voice commands) but it will be appreciated that a user may use any suitable means for inputting information and commands to the PC 100.

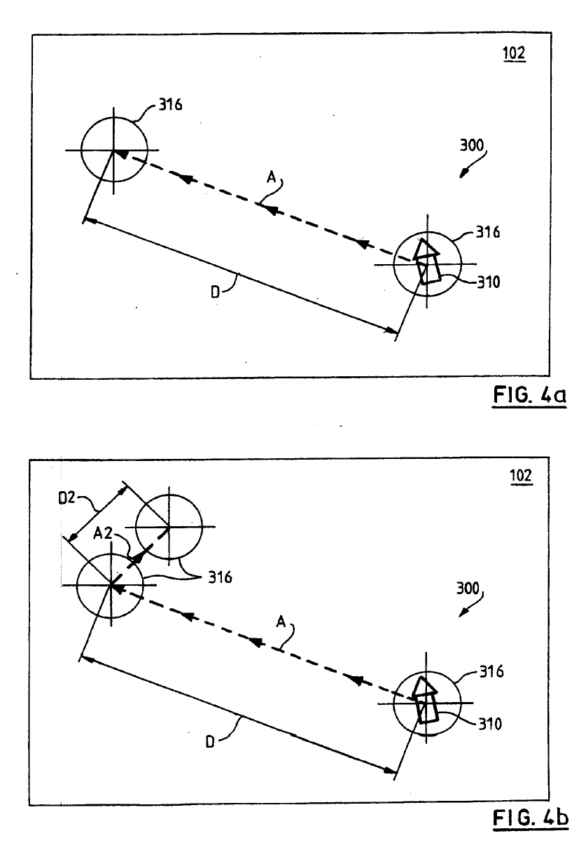

Referring now to FIG. 4a, illustrated is a method in accordance with a second embodiment of the present invention. In this arrangement, the cursor 310 has associated therewith a navigation marker 316 (the sizes of the cursor 310 and marker 316 are exaggerated for ease of illustration). The navigation marker comprises a crossed-hairs icon displayed on the screen 102 although it will be appreciated that the marker 316 could be represented by any symbol or shape.

The method in accordance with this embodiment of the invention is similar in many ways to the method in accordance with the first embodiment but differs in that, as a first step, the navigation marker 316 is moved in accordance with a user's inputted direction and distance indications that for ease of illustration are presented in FIG. 4a (by arrowed line A and distance line D) in the same manner as in FIGS. 3a and 3b.

While the PC 100 can be configured to move the cursor 310 simultaneously with the marker 316, the benefit of associating a marker 316 with the cursor 310 is best realised when the cursor 310 is repositioned as a subsequent step to the repositioning of the marker 316.

By moving only the marker 316 in a first step in accordance with a user's inputted direction and distance indications, a user can see from the new position occupied by the marker 316 where the cursor 310 will be relocated to in a subsequent step. The cursor 310 may be automatically relocated to the new position of the marker 316 after a small time delay unless the user issues a further command indicative of the fact that the user wishes to further reposition the marker 316 to a desired target position for the cursor 310. This further input by the user may comprise a “stop”, “ino” or “reposition” command or the like followed by further direction and distance indications as illustrated in FIG. 4b (by further arrowed line A2 and further distance line D2) that the PC 100 may or may not prompt the user for. The user may repeat this process until he is satisfied that the marker 316 is at or sufficiently adjacent the target position.

Alternatively, the subsequent step of repositioning the cursor 310 to the new position of the marker 316 may not occur until the user inputs a confirmation input such as “go” or “yes”, for example, which is recognised by the PC 100 as agreement by the user that the marker 316 is now at the user's target position and the cursor 310 can then be moved to be coincident with the marker 316 at its new position.

In this alternative arrangement, where the user fails to provide a confirmation input or provides a negative input such as “stop”, “no” or “reposition”, the PC 100 is configured to process one or more sets of further direction and distance indications until such time as the user provides a confirmation input commanding the PC 100 to now relocate the cursor 310 to the new position of the marker 316.

The PC 100 may also be configured such that the user is able to select to display or hide the navigation marker 316 through a suitable spoken input. When, the user commands the PC 100 to display the marker 316, the marker 316 may be displayed coincident with the cursor 310 at its current position or at any pre-selected position of the display screen 102 in accordance with a user's settings. The user's settings may be established on a first execution of the GUI but can be updated at any time in a manner that will be familiar to a skilled artisan. The user may establish through said settings a default whereby the marker 316 is always displayed on the display screen in response to PC 100 booting or the opening of a new program application etc.

The method in accordance with the second embodiment of the invention is also intuitive in the manner by which a user determines suitable direction and distance indications and may employ the same means as in the first embodiment for assisting a user in making such selections.

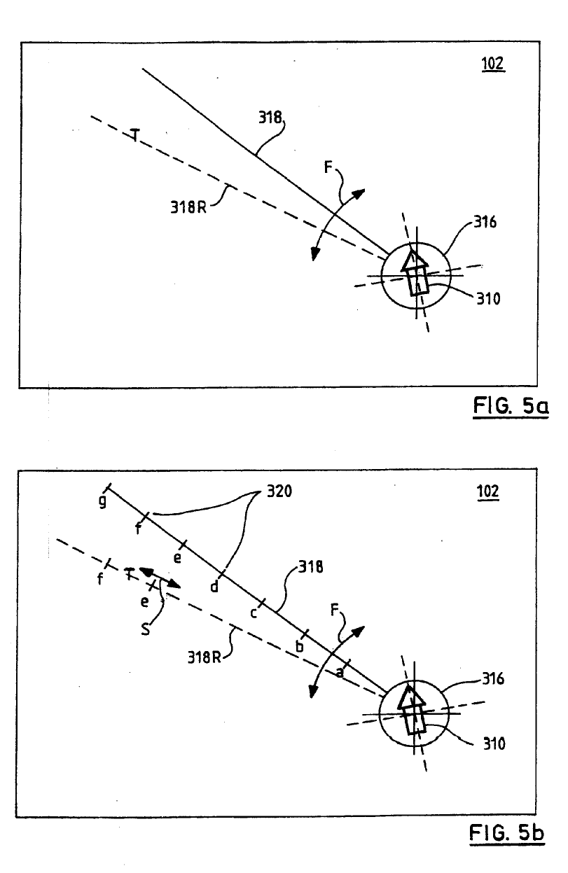

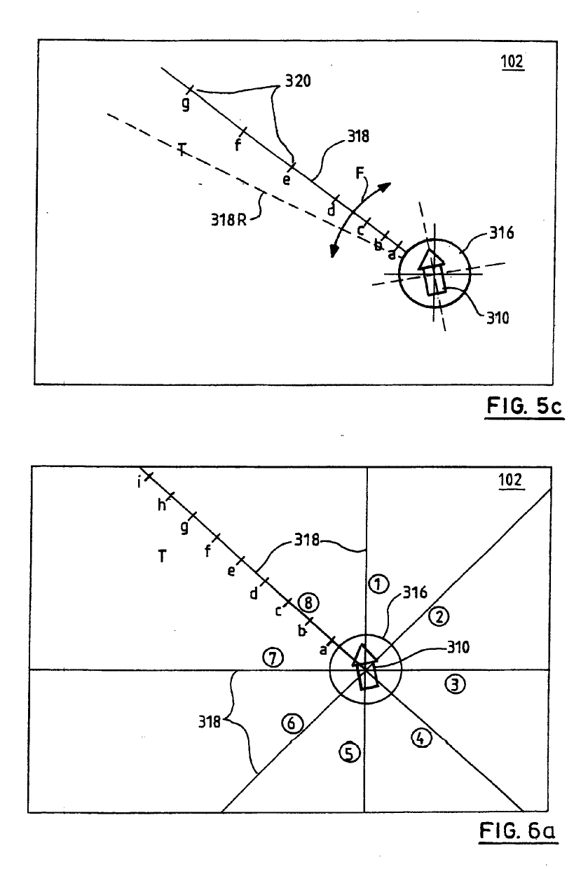

Referring now to FIG. 5a, illustrated is a third embodiment of the present invention in which the navigation marker 316 includes a single direction line 318 extending radially outwardly from the marker 316. The direction line 318 assists a user in envisaging a suitable direction indication for repositioning the marker 316 towards a target position (denoted by the character “T” in the figure) for the subsequent relocation of the cursor 316. The user's direction indication may be inputted in a form consistent with that of the first and second embodiments of the invention or comprise a direction measure related to the position of the displayed direction line 318.

In an alternative arrangement, the marker 316 including the direction line 318 may be rotatable (indicated by arrowed line “F” in the figure) in response to a suitable user input such as “rotate” to enable the user to control the position of the direction line 318 such that it intersects the target position “T” (illustrated by broken line 318R in the figure). The user command to “rotate” may be enhanced by additional commands such as “clockwise” or “right” and “ant-clockwise” or “left” to more quickly redirect the direction line 318 to intersect the target position “T”. The amount by which the direction line is to be rotated may be controlled by a user through an input indicative of the degree of rotation required. This may be expressed in a combined command such as “rotate left 30°” or “rotate left through a sixth”, for example. Alternatively, the marker 316 may rotate continuously through an angle up to 360° until the user issues a “stop” command although this a less preferred method of controlling rotation of the marker 316 since it requires the user's constant attention to issue the “stop” command. In a further arrangement, the marker 316 may commence rotating immediately it appears on the GUI display screen 102 and will continue to rotate until the user issues a command to the PC 100 to stop rotation of the marker 316. The alternative and further arrangements may be established as user preferences through user settings. The speed of rotation of the marker 316 may also be a feature established through the user's GUI settings.

Once the user has controlled rotation of the marker 316 such that the direction line 318 intersects the target position “T”, the PC 100 either waits for the user to input a confirmation of the selection of the direction line 318 as the user's direction indication or prompts the user to do so.

Whether the marker 316 is able to be rotated or not, either prior to or only once the user has inputted a direction indication (which may comprise confirming the direction line 318 as the indication once it is rotated to intersect the target position “T” or inputting a character representing the direction line 318), displayed on the direction line 318 are a plurality of distance sub-divisions 320 as illustrated in FIG. 5b. The sub-divisions 320 enable a user to more easily envisage a distance indication. This is particularly true of the case where the marker 316 is rotatable to cause the direction line 318 to intersect the target position “T”. The user can therefore very easily identify a suitable distance indication that will reposition the marker 316 to the target position “T”. The sub-divided direction line 318 may carry absolute or relative distance measurements (not shown) that the user can input as distance indications. It is preferable that the distance sub-divisions 320 are not displayed until the user has inputted a direction indication to avoid cluttering the display screen 102 with navigation marker information elements. The PC 100 may be configured to enable a user to select whether to display the distance sub-divisions 320 both prior and after or only after a user has inputted a direction indication.

The sub-divisions 320 on the direction line 318 may not be equally spaced as illustrated in FIG. 5c, being, in one arrangement, closer together nearest the marker 316. The relationship between the spacing of the sub-divisions 320 and distance from the marker 316 may be an exponential one. This is beneficial where a user wishes to further reposition the marker 316 after one or more previous steps in the same repositioning instance since the marker 316 is now likely to be close to the target position “T” and the increased density of sub-divisions 320 closest to the marker 316 improves the accuracy of a user's selection of a suitable further distance indication.

In a further arrangement as illustrated in FIGS. 5b and 5c, the sub-divisions 320 are identified by respective alpha-numeric characters or strings of such characters that can be inputted to the PC 100 as a user's distance indications and recognised as such by the PC 100.

The distance sub-divisions 320 may themselves be moveable along the direction line 318, either automatically or in response to a user input, to in effect scan that part of the direction line 318 adjacent thereto as a means of not only controlling the direction line 318 to intersect the target position “T” but to also cause a nearest distance sub-division to be coincident with said position. The user can then input the adjusted distance sub-division as his distance indication confident that the marker 316 will be relocated to a position exactly coincident with the target position “T”. As illustrated in FIG. 5b, the user may select either of distance sub-divisions 320e or 320f to scan (as indicated by arrowed line “S” in the figure) that part of the direction line 318 either in advance or behind it in a direction away from the marker 316. It will be appreciated that this feature of the invention may include other modifications including user adjustment of the speed of scanning by the distance sub-divisions, whether any or all distance sub-divisions scan automatically as a default setting, whether distance sub-divisions 320 scan the line in a reciprocating fashion or are returned to their intital positions once they reach the position of the next adjacent sub-division, etc.

In a method utilising the third embodiment of the invention, a user may be prompted by the PC 100 to input as a single input both a direction indication and a distance indication. Preferably, however, the user is firstly prompted for a direction indication. This may comprise the user inputting a direction indication as aforesaid and/or enabling the user to control rotation of the marker 316 to cause the direction line 318 to intersect the target position “T” as also hereinbefore described. Following this, as a subsequent input, the user is prompted by the PC 100 for a distance indication. This may comprise an alpha-numeric character or string displayed on the screen 102 that identifies a particular one of distance sub-divisions 320.

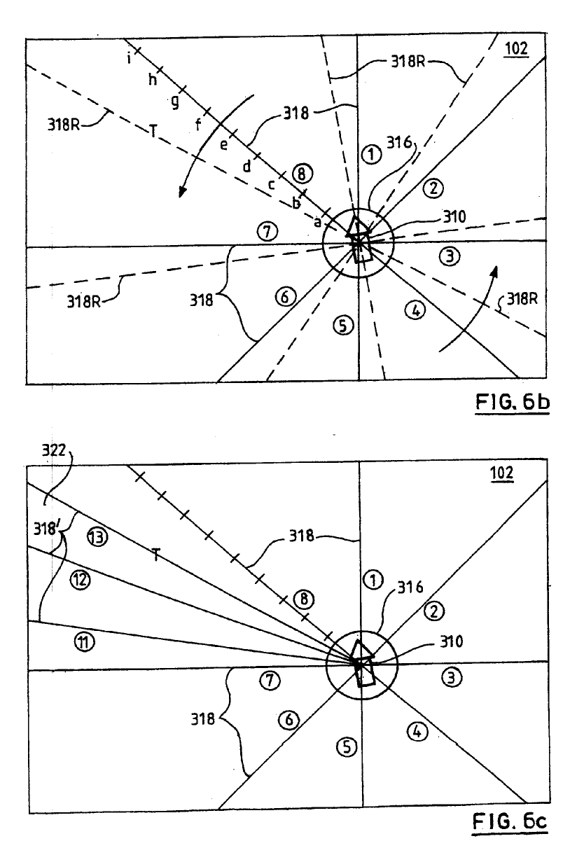

The embodiment of the invention illustrated by FIG. 6a utilises a plurality of directions lines 318. While these are shown as being equally spaced around the navigation marker 316, this need not be the case. These lines 318 may be arranged around only a portion (or sector) of the space surrounding the marker 316 and be spaced unequally (not shown) such that the angular spaces between adjacent lines 318 are larger nearest the edges of the sector. The provision of a plurality of direction lines 318 assists a user in more easily envisaging a suitable direction indication for a target position “T”. Each of the lines is identified by an alpha-numeric character that a user can use as his inputted direction indication. A user may choose as his direction indication the character associated with the line 318 that passes closest to the target position “T”.

Each of the lines carries distance sub-divisions 320 that are also encoded using alpha-numeric characters or strings of such characters, although only one such line is illustrated as doing so. The distance sub-divisions 320 may remain hidden until such time as a user inputs a direction indication and only the sub-divisions 320 of the line 318 identified by the user's inputted direction indication may be arranged to be displayed to avoid cluttering the display screen 102.

As illustrated in FIG. 6b, the marker 316 may be able to be rotated together with its direction lines 318 (denoted by dotted lines “318R” in the figure after rotation) such that one of said lines 318R(8) can be made to intersect the target position “T”. The marker 316 may be configured to rotate or be controlled to rotate only through a specified angular distance that may be set as equal to the smallest distance between any two direction lines 318 currently being displayed. Rotation of the marker 316 may also be controlled so as to return the marker and direction lines 318 to their initial positions once any direction line has rotated sufficiently to reach the position that a next adjacent direction line had initially occupied.

Rotation of the navigation marker 316 may be such that it is returned to its original rotational orientation on completion of a cursor 310 repositioning operation. Alternatively, it may remain in the rotational orientation it occupied during the last such operation.

Alternatively, as illustrated in FIG. 6c, once a user has inputted a direction indication identifying the direction line 318(8) that passes closest to the target position “T”, the PC 100 is configured to sub-divide a space 322 or sector bounded by the identified direction line 318(8) and a next direction line 318(1) (in a clockwise direction in this instance although it will be appreciated that the next adjacent line 318 may be chosen as the next adjacent line 318(7) in an anti-clockwise direction) to insert a plurality of further direction lines 318′ that are each encoded with respective alpha-numeric characters. A user can then select the further line 318′(13) that passes closest to the target position “T” as a new direction indication that updates the already inputted direction indication.

This is beneficial where the number of original direction lines 318 is small and thus the spaces between them are large, relatively speaking. The user is then able to introduce more closely spaced direction lines 318′ in a space or sector 322 of interest rather than cluttering the whole screen 102 with a large number of direction lines 318 extending in all directions outwardly from the marker 316. Although this process could be repeated, It is anticipated that it would not be necessary to perform more than one iteration to obtain a line 318′(13) that passes sufficiently close to the target position “T” that would satisfy the user's requirements.

The PC 100 may be configured to enable a user to select the number of lines comprising the original set of direction lines 318 and the second level set of lines 318′ that are to be displayed.

While various features of the present invention have been described with respect to specific embodiments thereof, it will be appreciated that such features can be implemented with all of the embodiments and therefore the invention is not limited by the specific embodiments that are provided by way of example only.

In summary, the present invention is directed to a voice controlled cursor, location pointer, mouse pointer or the like whereby a user's spoken input or inputs indicative of both a direction and a distance are employed to directly move the cursor from its current position towards a target position on a display of a graphical user interface (GUI) of a computing device. The cursor has a navigational marker associated therewith. In a first step, the marker is moved in response to at least one set of direction and distance indications inputted by a user to the computing device prior to moving the cursor to be co-incident with the marker at its new position. The marker is provided to enable a user to position it at a target position for the cursor prior to moving the cursor to said position.

What is claimed is:

1. A method of moving an element displayed on a computer display from a current position thereof towards a target position, the method comprising the steps of: receiving a user's input indicative of a direction and a distance; and
moving said element from its currently displayed position directly to a new position defined by a direction and by a distance derived from the user's input.

2. A method as claimed in claim 1, wherein that part of a user's input or inputs indicative of a direction comprises any of an angle relative to a datum, a compass direction relative to the orientation of the computer display and an alpha-numeric character encoding an angle or a direction indication.

3. A method as claimed in claim 1, wherein that part of a user's input or inputs indicative of a distance comprises any of an absolute distance, a relative distance and an alpha-numeric character encoding a distance indication.

4. A method as claimed in claim 2, wherein the navigation marker associated with the display element includes at least one line displayed on the computer display, said line extending generally radially outwardly from said navigation marker.

5. A method as claimed in claim 12, wherein the navigational marker can be rotated in response to a user input.

6. A method as claimed in claim 12, wherein at least one radially extending line of the navigation marker is subdivided into a plurality of distance indications.

7. A data processing system comprising:
a processor;
a memory coupled to the processor, said memory storing programs executable by the processor;
a display screen coupled to the processor for displaying images under the control of programs being executed by the processor;
the programs stored on the memory including a program for creating a graphical user interface (GUI) on the display screen;
wherein said GUI is responsive to a user's input indicative of a direction and a distance to move said element from its currently displayed position directly to a new position defined by a direction and by a distance derived from the user's input.

8. A system as claimed in claim 30, wherein said data processing system comprise any of a network computer, a Web-based television set top box, an Internet appliance, a handheld device, a personal digital assistant (PDA) and a mobile communication device.

9. A system as claimed in claim 30, wherein the GUI is configured to display a navigation marker in association with the display element.

10. A system as claimed in claim 39, wherein the GUI is configured to rotate navigational marker.

11. A system as claimed in claim 39, wherein the GUI is configured to display at least one radially extending line of the navigation marker with a plurality of distance indications.

12. A system as claimed in claim 48, wherein each of said subdivided distance indications of the at least one radially extending line has an alpha-numeric character associated therewith, wherein input of a selected character by a user comprises the user's distance indication.

13. A system as claimed in claim 48, wherein the size of the subdivided distance indications varies over the length of the radially extending line.

14. A system as claimed in claim 50, wherein the size of the subdivided distance indications is smallest closest to the marker.

15. A system as claimed in claim 51, wherein the size of the subdivided distance indications grows exponentially with distance from the marker.

16. A system as claimed in claim 50, wherein the size arrangement of the subdivided distance indications is determined from a user's settings.

17. A system as claimed in claim 48, wherein the GUI is configured to only display distance indications after a user has input a direction indication.

18. A system as claimed in claim 32, wherein the GUI is configured to display the navigational marker in response to a user input.

19. A system as claimed in claim 55, wherein the GUI is configured to display the marker at one of a predetermined position on the computer display and at the display element's current position in accordance with a user's settings.

20. A machine readable medium comprising computer code executable by a processor of a data processing system having a memory coupled to the processor, said memory storing programs executable by the processor, and a display screen coupled to the processor for displaying images under the control of the programs being executed by the processor, the programs stored on the memory including a program for creating a graphical user interface (GUI) on the display screen;
wherein said GUI code is executable to move a display element from its currently displayed position directly to a new position defined by a direction and by a distance derived from a user's input indicative of a direction and a distance.
